(19) United States
(12) Patent Application Publication
(10) Pub. No.: US 2016/0363508 A1
(43) Pub. Date: Dec. 15, 2016

(54) METHOD AND SYSTEM FOR INSPECTING A MOTOR VEHICLE SUBSYSTEM

(71) Applicant: GM GLOBAL TECHNOLOGY OPERATIONS LLC, Detroit, MI (US)

(72) Inventor: Klaus OSTERHAGE, Russelsheim (DE)

(73) Assignee: GM GLOBAL TECHNOLOGY OPERATIONS LLC, Detroit, MI (US)

(21) Appl. No.: 15/183,056

(22) Filed: Jun. 15, 2016

(30) Foreign Application Priority Data
Jun. 15, 2015 (DE) 102015007632.9

(51) Int. Cl. G01M 17/007; G01M 13/02

(52) U.S. Cl. CPC G01M 17/007; G01M 13/025

(57) ABSTRACT

A method and apparatus are disclosed for inspecting, in particular testing, a motor vehicle subsystem. A real carrier having a real first motor vehicle subsystem is loaded onto a whole vehicle test stand. The states of the first motor vehicle subsystem are determined while loading the carrier onto the whole vehicle test. A real second motor vehicle subsystem is loaded onto a subsystem test stand based on the determined states. The states of the second motor vehicle subsystem are determined while loading it onto the subsystem test stand.

### CROSS-REFERENCE TO RELATED APPLICATION

This application claims priority to German Patent Application No. 102015007632.9, filed Jun. 15, 2015, which is incorporated herein by reference in its entirety.

### TECHNICAL FIELD

The present disclosure pertains to a method and a system for inspecting, in particular testing, a motor vehicle subsystem, as well as to a computer program product for implementing the method.

### BACKGROUND

Motor vehicle subsystems such as chasses or chassis subsystems, for example wheel suspensions, are to be inspected, in particular tested for service life, durability or the like, in particular as early in a vehicle development process as possible.

In general, measurement runs may be made with real motor vehicles that exhibit the subsystems. However, this disadvantageously requires drivable motor vehicles. In addition, the latter must also largely correspond to the motor vehicles in which the subsystems to be developed are to be subsequently used, for example in terms of their mass distribution, so as to obtain the most meaningful measurements possible.

Correspondingly, such measurement runs are routinely only possible in a relatively late stage of development. In addition, measurement runs are as a rule not precisely reproducible, thereby reducing the utility, in particular the comparability, of the measurements.

US 2007/0260438 A1 proposes a test setup for simulating the characteristics of a vehicle that exhibits a subsystem. The test setup exhibits a subsystem test stand for imposing a test state onto the subsystem and a simulation model, which represents the vehicle without the subsystem.

A simulation can be available early in the vehicle development process, and also permits reproducible measurements on the subsystem test stand. However, the measurements are routinely less meaningful than measurements during measurement runs with real motor vehicles, in particular due to modeling inaccuracies.

### SUMMARY

The present disclosure provides an improved inspection of a motor vehicle subsystem. In one aspect of the present disclosure, a real or physical carrier which has or will have a real or physical first motor vehicle subsystem fastened to it, in particular detachably fastened, is loaded onto a whole vehicle test stand equipped with software and/or hardware, which in one embodiment exhibits one or more actuators and/or controls the latter or is designed or equipped with software and/or hardware for this purpose.

While loading the carrier with the first motor vehicle subsystem onto the whole vehicle test stand, states of the first motor vehicle subsystem are determined in one embodiment, with software or hardware for this purpose, which in one embodiment exhibits one or more sensors and/or receives data from the latter or is designed or equipped with software and/or hardware for this purpose.

In particular during and/or after loading the carrier with the first motor vehicle subsystem onto the whole vehicle test bench, a real or physical second motor vehicle subsystem is loaded onto a subsystem test stand based or depending on the determined states in an embodiment, with software and/or hardware for this purpose, which in one embodiment exhibits one or more actuators and/or controls the latter or is designed or equipped with software and/or hardware for this purpose.

While loading the second motor vehicle subsystem onto the subsystem test stand, states of the second motor vehicle subsystem are determined in an embodiment, in particular with a means designed or equipped with software and/or hardware for this purpose, which in one embodiment exhibits one or more sensors and/or receives data from the latter or is designed or equipped with software and/or hardware for this purpose.

By loading the second motor vehicle subsystem onto the subsystem test stand based or depending on the states that are or were determined while loading the real carrier with the real first motor vehicle subsystem onto the whole vehicle test stand, the second motor vehicle subsystem can in one embodiment advantageously be inspected, in particular tested or checked, in particular for its service life.

In particular, the loads on the subsystem test stand can in one embodiment yield more meaningful results than loads based on a computer (virtual) simulation model of the motor vehicle. Additionally or alternatively, the states can in one embodiment be determined in the process of loading onto the whole vehicle test stand in order to inspect a motor vehicle subsystem early on already, in particular without a drivable motor vehicle, and/or under reproducible and/or in particular variably predeterminable boundary conditions.

In one embodiment, the carrier is loaded onto the whole vehicle test stand based on stored road data and/or control inputs, in particular with a means designed or equipped with software and/or hardware for this purpose, which in one embodiment exhibits one or more actuators and/or controls the latter or is designed or equipped with software and/or hardware for this purpose.

In one embodiment, the process of loading the carrier onto the whole vehicle test stand can encompass, in particular be, a multi-, in particular six-axis, and/or dynamic loading, in particular of wheel or tire contact surfaces or attachments of the carrier onto the whole vehicle test stand corresponding thereto, for example via the controlled or regulated variable lifting and/or exertion of forces and/or torques.

In one embodiment, the control inputs can be or can have been input while loading the carrier onto the whole vehicle test stand and/or in advance, in particular by a user or test driver. In particular, they can encompass or represent steering, accelerating, braking and/or shifting operations. Taking stored road data and/or control inputs into account makes it possible in one embodiment to advantageously simulate measurement runs, in particular realistic and/or varying measurement runs. In a further development, the stored road data are or were determined based on one or more real measurement runs of a real motor vehicle on a real road. In this way, measurement runs can in one embodiment advantageously be simulated on this or these real road(s).

Additionally, or alternatively, the stored road data can in a further development describe one or more road surfaces, in particular kinematically, for example in the form of a height profile, and/or kinetically, for example in the form of friction coefficients. Using road data that describe a road surface advantageously allows various or varyingly adjusted carriers and/or carriers equipped with motor vehicle subsystems to simulate the same measurement run on the whole vehicle test stand. Using road data that describe several road surfaces advantageously allows carriers to simulate various measurement runs on the whole vehicle test stand.

In one embodiment, the carrier is a variable or adjustable carrier, in particular a carrier with variable or adjustable mass, mass distribution, stiffness(es), attenuation(s), dimension(s), interface(s) and/or interface arrangement(s). As a result, various motor vehicles can advantageously be simulated in one embodiment.

In a further development, the carrier was or is adjusted prior to its loading so as to represent or simulate or reproduce areal motor vehicle, in particular with respect to its mass, mass distribution, stiffness(es), attenuation(s), dimension(s), interface(s) and/or interface arrangement(s). For this purpose, the carrier can in one embodiment exhibit adjustable masses and/or structures, in particular an adjustable wheel stand, adjustable or variable interfaces for attaching or fastening drives, drivetrains, exhaust systems, bodies, interior systems and/or real substitute models that simulate the latter.

In one embodiment, the subsystem test stand exhibits fewer (loading or moving) axis than the whole vehicle test stand, in particular at most four, in particular at most three, in particular at most one. As a result, in one embodiment, an advantageous, in particular compact and/or favorable and/or specialized subsystem test stand can be used, and/or a more realistic, in particular multi-axis load (of the carrier) can be established by the contrastingly multi-axis whole vehicle test stand.

In one embodiment, the first and second motor vehicle subsystems are the same type, in particular structurally the same, in particular identical. In particular, the first motor vehicle subsystem can be a precursor, in particular a prototype, and/or the second motor vehicle subsystem can by contrast be a later version of the same subsystem type, so that, in one embodiment, the first motor vehicle subsystem can already be measured on the whole vehicle test stand very early on in the development process, and the second motor vehicle subsystem can then be inspected, in particular in greater detail, on the subsystem test stand, which in particular is specialized for this purpose.

In one embodiment, the first and/or second motor vehicle subsystem can exhibit, in particular be, an engine, a drivetrain, a chassis, an exhaust system and/or a sub-system thereof, in particular a transmission and/or a clutch and/or an attachment of the drivetrain, an axle and/or wheel suspension and/or attachment of the chassis or an attachment of the exhaust system, or a part thereof.

In one embodiment, this makes it possible to advantageously inspect these motor vehicle sub-systems or parts thereof. The states of the first motor vehicle subsystem determined on the whole vehicle test stand and/or the states of the second motor vehicle subsystem determined on the subsystem test stand can each exhibit, in particular be, kinematic variables, in particular deflections and/or deformations, and/or kinetic variables, in particular forces and/or torques or stresses.

In one embodiment, the method is implemented once again after the states of the first motor vehicle subsystem have been determined. The variable carrier is or was adjusted beforehand to represent or simulate or reproduce another real motor vehicle, and/or wherein another real first motor vehicle subsystem is or was fastened to the carrier beforehand, and also, in particular later, another real second motor vehicle subsystem is loaded in the subsystem test stand, during which states of this second subsystem are determined. Additionally or alternatively, the same or another real second motor vehicle subsystem can be loaded in another subsystem test stand based on the determined states of the first motor vehicle subsystem, and states of this second subsystem can here be determined.

Additionally or alternatively, another one or more additional first motor vehicle subsystems can be attached to the carrier during the process of loading onto the whole vehicle test stand, and states of these additional first motor vehicle subsystems can be determined, and one or more additional second motor vehicle subsystems can each be loaded in subsystem test stands based on the determined states of the first subsystems allocated to them, and states of these additional second motor vehicle subsystems can here be determined so as perform a parallel inspection of several second motor vehicle subsystems, for example a chassis, a drive and/or an exhaust system or sub-systems thereof.

In one embodiment, this makes it possible in particular to consider changes in the vehicle during the development process. In one aspect of the present disclosure, a system is designed or equipped, in particular with software and/or hardware, for implementing a method described herein, and/or exhibits corresponding means.

In the sense of the present disclosure, a means can be designed as hardware and/or software, in particular exhibit an in particular digital processing unit, in particular a microprocessor unit (CPU), preferably data- or signal-connected with a memory and/or bus system, and/or one or more programs or program modules. The CPU can be designed to execute commands implemented as a program stored in a memory system, acquire input signals from a data bus and/or send output signals to a data bus. A memory system can exhibit one or more, in particular various, storage media, in particular optical, magnetic, solid-state and/or other nonvolatile media. The program can be constituted in such a way as to embody or be able to implement the methods described herein, so that the CPU can execute the steps of such a method, and thus in particular inspect, in particular test, a motor vehicle subsystem. The implementation of one or more steps of the method is partially or completely automated in one embodiment.

### BRIEF DESCRIPTION OF THE DRAWINGS

The present disclosure will hereinafter be described in conjunction with the following drawing figures, wherein like numerals denote like elements.

FIG. 1 shows a system according to one embodiment of the present disclosure; and

FIG. 2 is a flowchart illustrating a method according to one embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

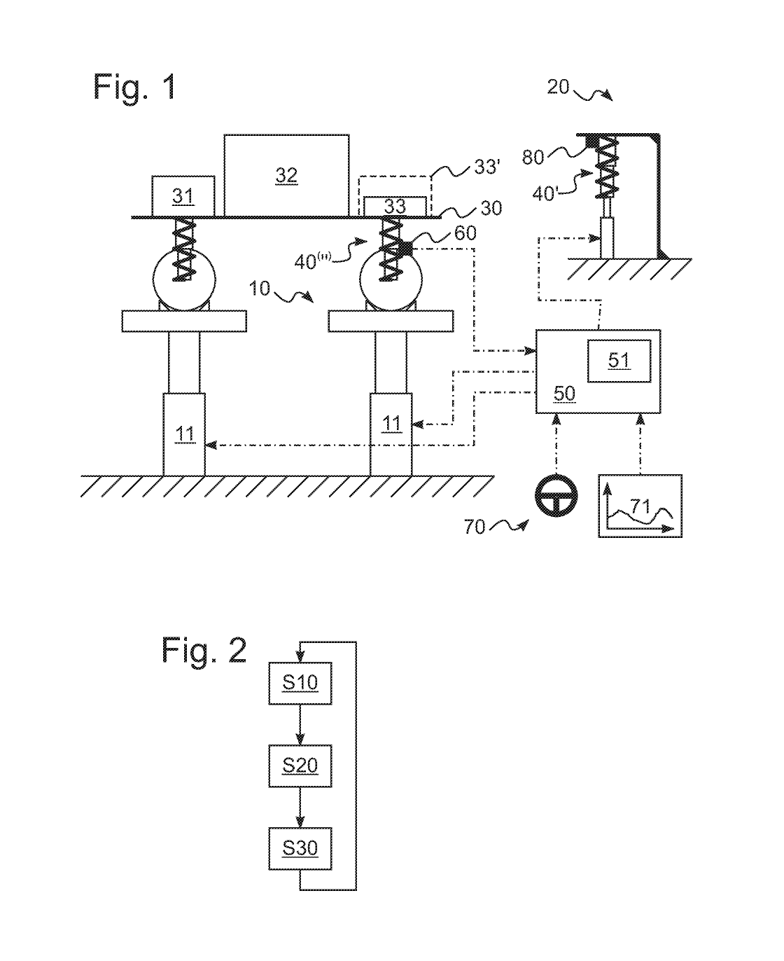

FIG. 1 shows a system for inspecting a motor vehicle subsystem according to one embodiment of the present disclosure. The present disclosure will be exemplarily explained in greater detail below based on the example of a test on a wheel suspension, but can likewise also be used for other motor vehicle subsystems or sub-systems, such as a drive or exhaust system.

The system exemplarily encompasses a six-axis whole vehicle test stand 10 with four lifting cylinders 11 and a single-axis subsystem test stand in the form of a wheel suspension test stand 20. Arranged on the whole vehicle test stand 10 is a real, variable carrier 30, which exhibits substitute models or masses 31, 32 and 33 for an engine 31, a body with interior 32 and an exhaust system 32. A real, first motor vehicle subsystem in the form of a prototype for a new wheel suspension 40 is attached to the carrier 30. The same type of wheel suspension 40′ of a later or more advanced development stage is subsequently attached to the wheel suspension test stand 20 and tested, for example for its service life in specific driving modes.

A computer 50 is set up, in particular in terms of programming, to implement a method according to an embodiment of the present disclosure that is explained below, in particular with respect to FIG. 2, and for this purpose exhibits a computer program product in the form of a memory or storage medium 51 with a corresponding program code. The computer 50 actuates the lifting cylinders 11 of the whole vehicle test stand 10, as well as an actuator of the wheel suspension test stand 20, as denoted by the dash-dot signal and data arrows on FIG. 1.

On the one hand, it receives measuring data from a sensor 60, which detects deflections and/or deformations and/or forces or stresses of the wheel suspension 40. In addition, the computer 50 receives control inputs from a corresponding input means 70 before or while loading the carrier 30 onto the whole vehicle test stand 10 as explained below, for example in the form of steering operations. Before or while loading the carrier 30 onto the whole vehicle test stand 10, the computer 50 further receives stored road data 71, which describe road surfaces and were determined based on measurement runs with real vehicles.

In a first step S10, the computer 50 actuates the lifting cylinders 11 of the whole vehicle test bench 10 based on the stored road data 71 as well as the control inputs from the input means 70, so as to dynamically load the carrier 30 with the prototype of the new wheel suspension 40. During this loading process, the computer 50 determines deflections, deformations and/or forces or stresses of the wheel suspension 40 based on the data from the sensor 60.

In an ensuing second step S20, the computer 50 triggers the actuator of the wheel suspension test stand 20 based on these determined deflections, deformations and/or forces or stresses, so as to dynamically load the same type of wheel suspension 40′ from the later development stage. During this loading process, the computer 50 determines deflections, deformations and/or forces or stresses of the wheel suspension 40′ on the wheel suspension test stand 20 based on the data from the sensor 80.

In this way, the wheel suspension 40′ can be advantageously tested on the wheel suspension test stand 20 specially set up for this purpose, in particular taking as the basis the loads that arise while traveling over a road surface described by the road data 71, with control inputs entered with the means 70, and with a motor vehicle simulated by the carrier 30 with the equivalent masses 31-33.

For example, should a mass of the exhaust system change during the development process, the method described above can be repeated, wherein the carrier 30 is adjusted in a step S30 prior to loading on the whole vehicle test stand 10 by attaching another equivalent mass 33′ for the exhaust system, so as to represent the real motor vehicle with the modified exhaust system. This is denoted by dashed lines on FIG. 1.

Additionally or alternatively, various boundary conditions can be simulated by using different control inputs and/or road data 71. For example, should a mass of the wheel suspension change during the development process, the method described above can also be repeated, wherein the carrier 30 is adjusted in a step S30 prior to loading on the whole vehicle test stand 10 by attaching another corresponding equivalent mass 40″, so as to represent the real motor vehicle with the modified wheel suspension.

Additionally or alternatively, real wheel suspensions can also be loaded and inspected on other wheel suspension test stands based on the states determined while loading the wheel suspension 40 or 40″ onto the whole vehicle test stand, in particular deflections and/or deformations and/or forces or stresses.

Additionally or alternatively, other first motor vehicle subsystems in the form of engines or exhaust systems can be attached to the carrier 30 in place of the equivalent masses 31, 33/33′ for the engine or exhaust system while loading the carrier 30 in step S10, and the states of these other first motor vehicle subsystems can be determined with the corresponding sensors. In step 20, other second motor vehicle subsystems in the form of engines or exhaust systems can then be loaded in parallel, in particular simultaneously, onto corresponding subsystem, in particular engine or exhaust system, test stands, during which the states of these other second motor vehicle subsystems can be determined with corresponding sensors, as explained exemplarily above for the wheel suspension 40-40″.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A method for inspecting, in particular testing, a motor vehicle subsystem (40′), with the following steps:
loading a real carrier having attached thereto a real first motor vehicle subsystem onto a whole vehicle test stand;
determining at least one state of the first motor vehicle subsystem while loading the carrier onto the whole vehicle test stand;
loading a real second motor vehicle subsystem onto a subsystem test stand based on the determined states; and
determining at least one state of the second motor vehicle subsystem while loading it onto the subsystem test stand.

17. The method according to claim 16, further comprising loading the carrier onto the whole vehicle test stand based on at least one of stored road data and control inputs.

18. The method according to claim 17, wherein the carrier is loaded with stored road data determined based on at least one of a test measurement run and a described road surface.

19. The method according to claim 16, further comprising setting at least one of a mass, mass distribution, stiffness, attenuation, dimension, interface and interface arrangement on the carrier prior to loading, wherein the carrier represents a real motor vehicle.

20. The method according to claim 16, further comprising loading the whole vehicle test stand in a first set of axes, and loading the subsystem test stand in a second set of axes, which is less than the first set of axes.

21. The method according to claim 16, wherein the first and second motor vehicle subsystem exhibit at least one of a drive, drivetrain, chassis, exhaust system or a sub-system thereof.

22. The method of claim 21, wherein the first and second motor vehicle subsystems are of the same type.

23. The method of claim 16, wherein the first and second motor vehicle subsystems are of the same type.

24. The method according to claim 16, wherein the at least one state exhibits one of deflection, deformation, force and torque.

25. A system for inspecting, in particular testing, a motor vehicle subsystem comprising an electronic controller configured to be operably coupled to a whole vehicle test stand and a subsystem test stand, the electronic controller configured to:
load a real carrier having attached thereto a real first motor vehicle subsystem onto the whole vehicle test stand;
determine at least one stats of the first motor vehicle subsystem while loading the carrier onto the whole vehicle test stand;
load a real second motor vehicle subsystem onto the subsystem test stand based on the determined state; and
determine at least one state of the second motor vehicle subsystem during loading onto the subsystem test stand.

26. The system according to claim 25, wherein the electronic controller is configured to load the carrier onto the whole vehicle test stand based on at least one of stored road data and control inputs.

27. The system according to claim 26, wherein the carrier is loaded with stored road data determined based on at least one of a test measurement run and a described road surface.

28. The system according to claim 25, further comprising a variable carrier having at least one of a mass, mass distribution, stiffness, attenuation, dimension, interface and interface arrangement on the variable carrier prior to loading, wherein the variable carrier represents a real motor vehicle.

29. The system according to claim 25, further comprising a whole vehicle test stand and a subsystem test stand, wherein the electronic controller is operably coupled thereto.

30. The system according to claim 25, wherein the first and second motor vehicle subsystem exhibit at least one of a drive, drivetrain, chassis, exhaust system or a sub-system thereof.

31. The system of claim 30, wherein the first and second motor vehicle subsystems are of the same type.

32. The system of claim 25, wherein the first and second motor vehicle subsystems are of the same type.

33. The system according to claim 25, wherein the at least one state exhibits one of deflection, deformation, force and torque.

34. A non-transitory computer readable medium comprising a program code, which when executed by a computer, implements a testing method comprising:
loading a real carrier having attached thereto a real first motor vehicle subsystem onto a whole vehicle test stand;
determining at least one state of the first motor vehicle subsystem while loading the carrier onto the whole vehicle test stand;
loading a real second motor vehicle subsystem onto a subsystem test stand based on the determined states; and
determining at least one state of the second motor vehicle subsystem while loading it onto the subsystem test stand.
